(19) United States
(12) Patent Application Publication
(10) Pub. No.: US 2006/0200489 A1
(43) Pub. Date: Sep. 7, 2006

(54) Company modeling

(75) Inventors: Nicholas Justin Lowe, Mercer Island, WA (US); Kathlyn M. Gallines, North Hampton, NH (US); Peter Johannsen, Frederiksberg (DK); Samantha Britney, Seattle, WA (US); Finn Rode, Gedved (DK); Thomas Jensen, Lyngby (DK); Jakob Nielsen, Redmond, WA (US); Cary Lane Rohwer, Duvall, WA (US); Robert William Edmiston, Kirkland, WA (US); James Utzschneider, Mercer Island, WA (US); Susan Bohn, Redmond, WA (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/345,965

(22) Filed: Feb. 2, 2006

Related U.S. Application Data
(60) Provisional application No. 60/658,130, filed on Mar. 3, 2005.

(51) Int. Cl. G06F 17/00

(52) U.S. Cl. 707/102

(57) ABSTRACT

A company is compared to a generic company model to identify differences between the company and the generic company model. The generic company model includes a work model that describes sequences of tasks that form processes performed within a generic company and a persona model that describes generic personas in the generic company and tasks that each generic persona performs. The differences between the generic company model and the company are used to modify the generic company model to form a company-specific model.

### REFERENCE TO RELATED APPLICATIONS

The present application claims priority benefit to U.S. Provisional Application 60/658,130 filed on Mar. 3, 2005.

### BACKGROUND

Companies often engage software consultants to analyze their business and identify areas where new software could be written to improve the efficiency of the business. The consultants analyze the business by documenting processes performed within the business and determining which processes could be improved through software. Once the consultants have identified the processes that can be improved through software, programmers are employed to generate the appropriate software.

The discussion above is merely provided for general background information and is not intended to be used as an aid in determining the scope of the claimed subject matter.

### SUMMARY

A company is compared to a generic company model to identify differences between the company and the generic company model. The generic company model includes a work model that describes sequences of tasks that form processes performed within a generic company and a persona model that describes generic personas in the generic company and tasks that each generic persona performs. The differences between the generic company model and the company are used to modify the generic company model to form a company-specific model.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one computing environment in which some embodiments may be practiced.

FIG. 2 is a block diagram of an alternative computing environment in which some embodiments may be practiced.

FIG. 3 is a diagram of a company model under one embodiment of the invention.

FIG. 4 is a flow diagram for forming and using company specific models.

FIG. 5 is a block diagram of elements used to form and use company specific models.

FIG. 6 is a diagram showing organization charts for a large and a small marketing department.

FIG. 7 is a diagram of organization charts for small and medium IT departments.

FIG. 8 is a diagram of organization charts for a simple and complex sales department.

### DETAILED DESCRIPTION

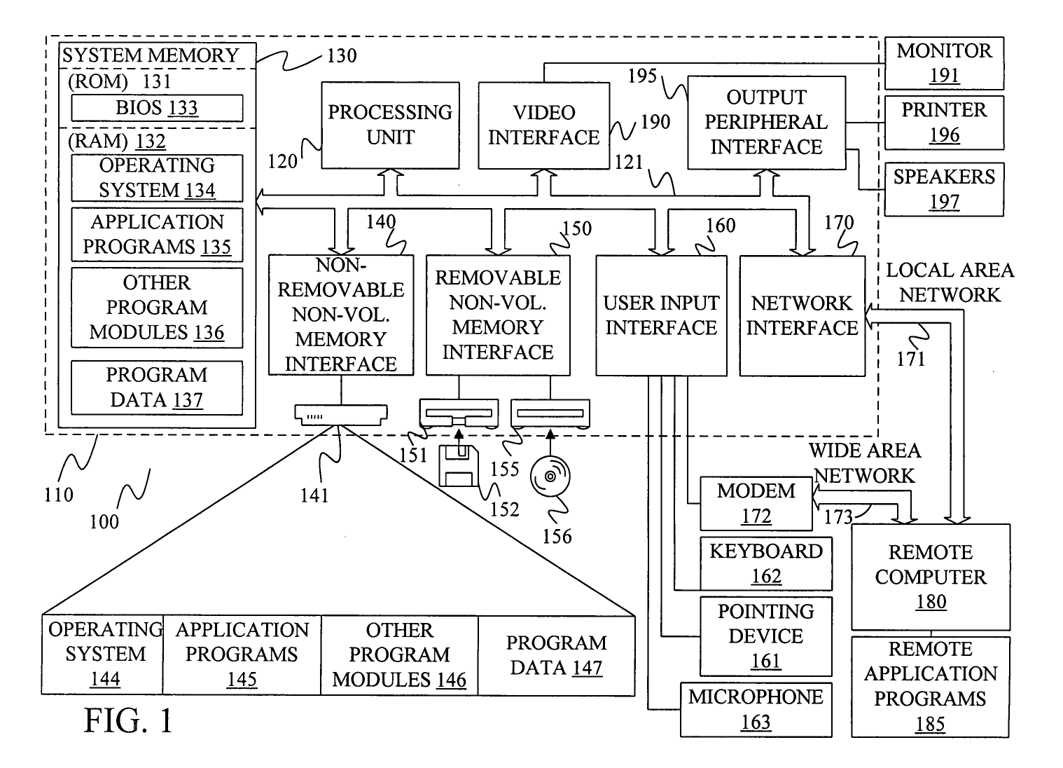

FIG. 1 illustrates an example of a suitable computing system environment 100 on which embodiments may be implemented. The computing system environment 100 is only one example of a suitable computing environment and is not intended to suggest any limitation as to the scope of use or functionality of the claimed subject matter. Neither should the computing environment 100 be interpreted as having any dependency or requirement relating to any one or combination of components illustrated in the exemplary operating environment 100.

Embodiments are operational with numerous other general purpose or special purpose computing system environments or configurations. Examples of well-known computing systems, environments, and/or configurations that may be suitable for use with various embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Embodiments may be described in the general context of computer-executable instructions, such as program modules, being executed by a computer. Generally, program modules include routines, programs, objects, components, data structures, etc. that perform particular tasks or implement particular abstract data types. Some embodiments are designed to be practiced in distributed computing environments where tasks are performed by remote processing devices that are linked through a communications network. In a distributed computing environment, program modules are located in both local and remote computer storage media including memory storage devices.

With reference to FIG. 1, an exemplary system for implementing some embodiments includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

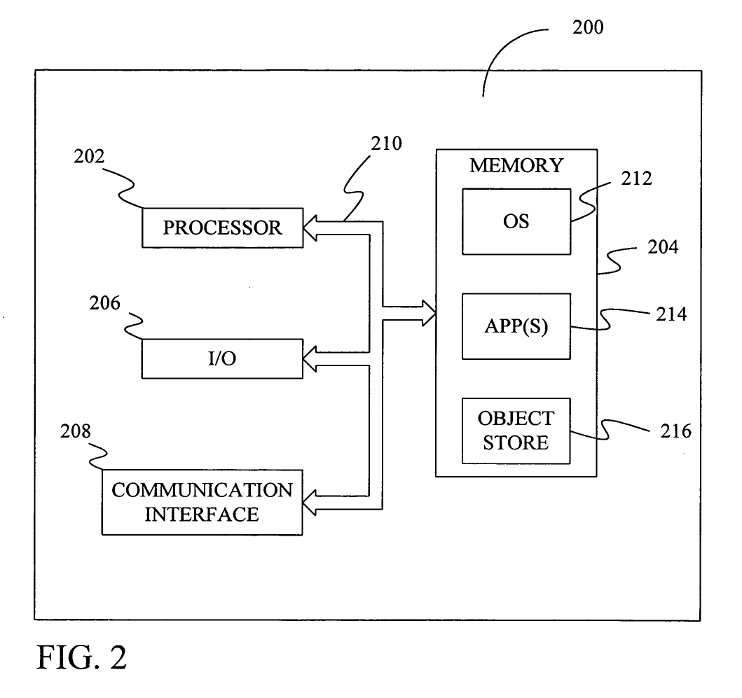

FIG. 2 is a block diagram of a mobile device 200, which is an exemplary computing environment. Mobile device 200 includes a microprocessor 202, memory 204, input/output (I/O) components 206, and a communication interface 208 for communicating with remote computers or other mobile devices. In one embodiment, the afore-mentioned components are coupled for communication with one another over a suitable bus 210.

Memory 204 is implemented as non-volatile electronic memory such as random access memory (RAM) with a battery back-up module (not shown) such that information stored in memory 204 is not lost when the general power to mobile device 200 is shut down. A portion of memory 204 is preferably allocated as addressable memory for program execution, while another portion of memory 204 is preferably used for storage, such as to simulate storage on a disk drive.

Memory 204 includes an operating system 212, application programs 214 as well as an object store 216. During operation, operating system 212 is preferably executed by processor 202 from memory 204. Operating system 212, in one preferred embodiment, is a WINDOWS® CE brand operating system commercially available from Microsoft Corporation. Operating system 212 is preferably designed for mobile devices, and implements database features that can be utilized by applications 214 through a set of exposed application programming interfaces and methods. The objects in object store 216 are maintained by applications 214 and operating system 212, at least partially in response to calls to the exposed application programming interfaces and methods.

Communication interface 208 represents numerous devices and technologies that allow mobile device 200 to send and receive information. The devices include wired and wireless modems, satellite receivers and broadcast tuners to name a few. Mobile device 200 can also be directly connected to a computer to exchange data therewith. In such cases, communication interface 208 can be an infrared transceiver or a serial or parallel communication connection, all of which are capable of transmitting streaming information.

Input/output components 206 include a variety of input devices such as a touch-sensitive screen, buttons, rollers, and a microphone as well as a variety of output devices including an audio generator, a vibrating device, and a display. The devices listed above are by way of example and need not all be present on mobile device 200. In addition, other input/output devices may be attached to or found with mobile device 200.

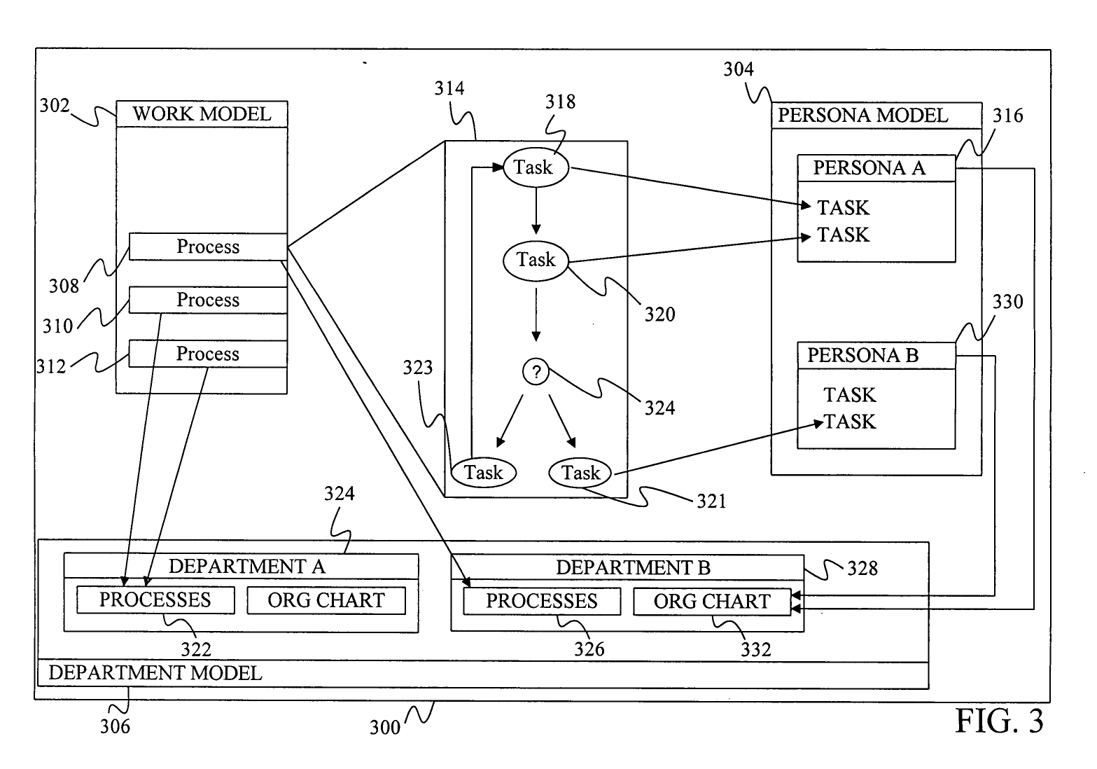

As shown in FIG. 3, embodiments of the present invention utilize a company model 300 that is formed of three interrelated models denoted as work model 302, persona model 304 and department model 306. Work model 302 provides a set of processes 308, 310 and 312 performed within the company represented by company model 300. Within work model 302, each process, such as process 308 is described as a flow of tasks, events, and decision points. For example, flow 314 represents the flow of tasks and decision points for process 308, and includes tasks 318, 320, 321 and 323 and decision point 324. Tasks are portions of the process that are performed by a person in the company; events are changes in status that can trigger a process to begin, end or continue, and decision points are states in the flow that can decide which of a plurality of tasks should be performed next given a set of criteria.

Under company model 300, each task in work model 302 is assigned to a persona within persona model 304. For example, persona 316 has tasks 318 and 320 of process 308 assigned to it and persona 330 has task 321 assigned to it. A persona represents a generic person in a company who satisfies certain characteristics and performs certain tasks. For example, a general manager would be one type of persona and a product designer would be another type of persona. In addition to the tasks assigned to it, a persona in persona model 304 may include a description of the general characteristics of the persona.

The personas of persona model 304 and the processes of work model 302 are organized into departments under department model 306. For example, processes 310 and 312 are placed as processes 322 under Department A 324. Similarly, process 308 is placed in processes 326 of Department B 328. In addition, personas 316 and 330 are organized in organization chart 332 under department B 328.

Thus, within company model 300, work model 302, persona model 304 and department model 306 are linked together and provide a comprehensive model of the structure of a company, the people within the company, the tasks performed by the company, and the assignment of responsibility for those tasks to individual people within the company.

Under one embodiment, a company specific model is constructed by modifying a generic company model so that it describes the processes, people, and organization of the specific company.

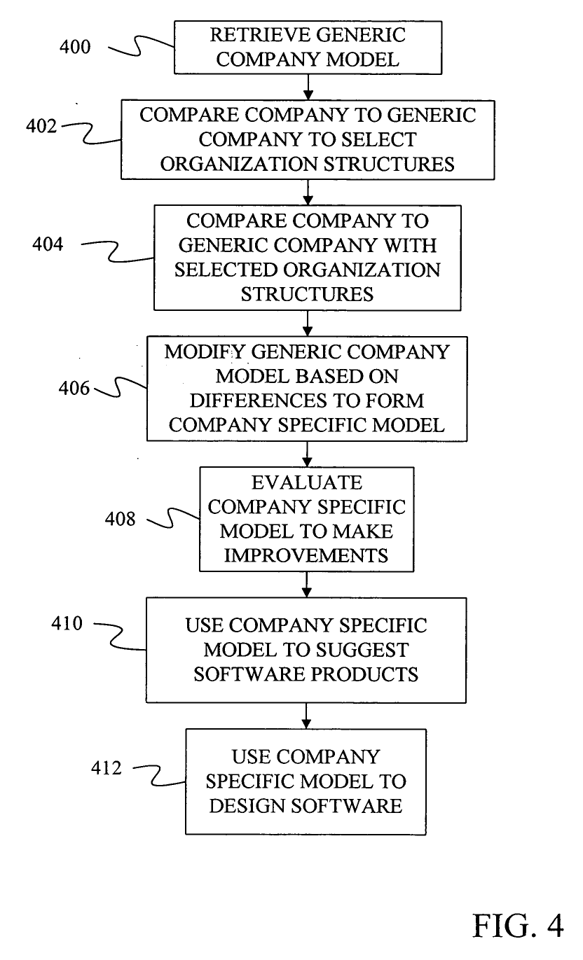

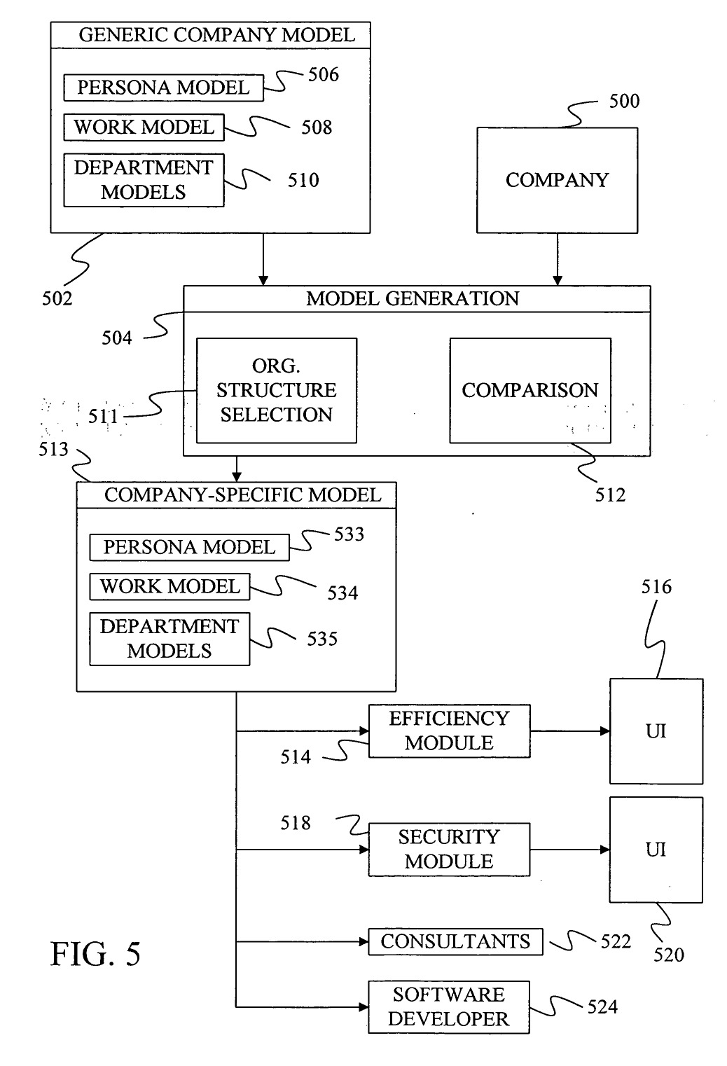

The process of forming a company specific model is shown in FIG. 4, which describes elements in the block diagram of FIG. 5. At step 400 of FIG. 4, a generic company model 502 is retrieved. Generic company model 502 includes a persona model 506, a work model 508 and a department model 510 that together describe the departments, personnel, and processes performed in most companies. Generic company model 502 can be formed by analyzing the structure of multiple companies, identifying the processes that are common to a majority of the companies, the departments found in a majority of the companies, and the organizational structures common to a majority of the companies.

While companies of different sizes generally perform the same processes, they tend to have different organization structures and have different sets of personas. In particular, personas found in large companies may not be found in smaller companies. To address this, an embodiment of the present invention provides different organization structures within department model 510 for different sized companies or for different levels of complexity within a department.

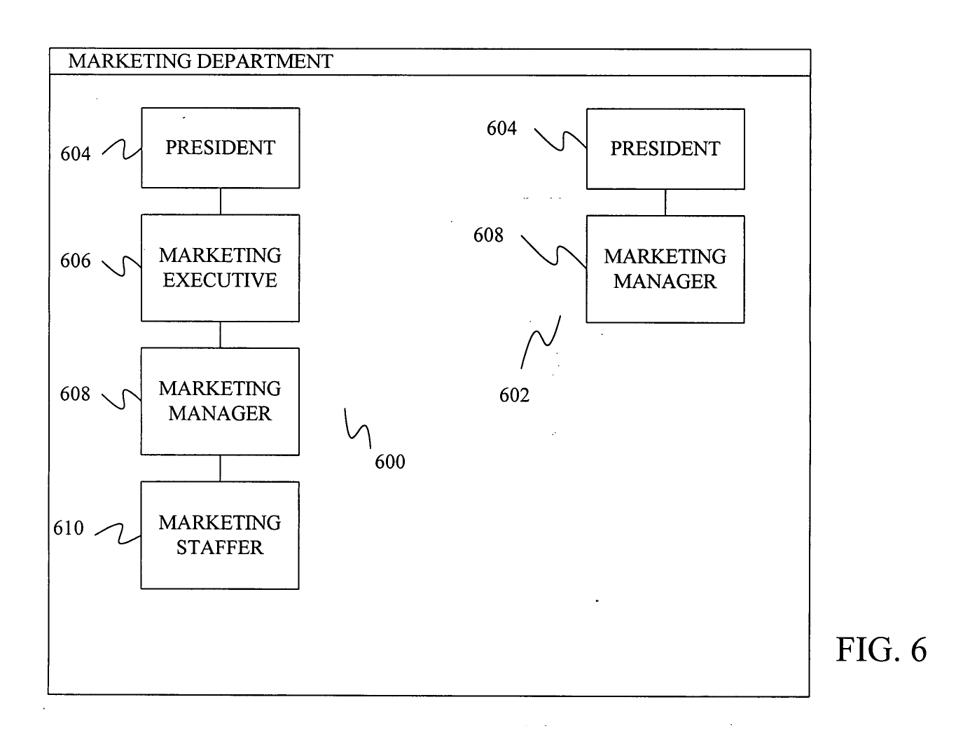

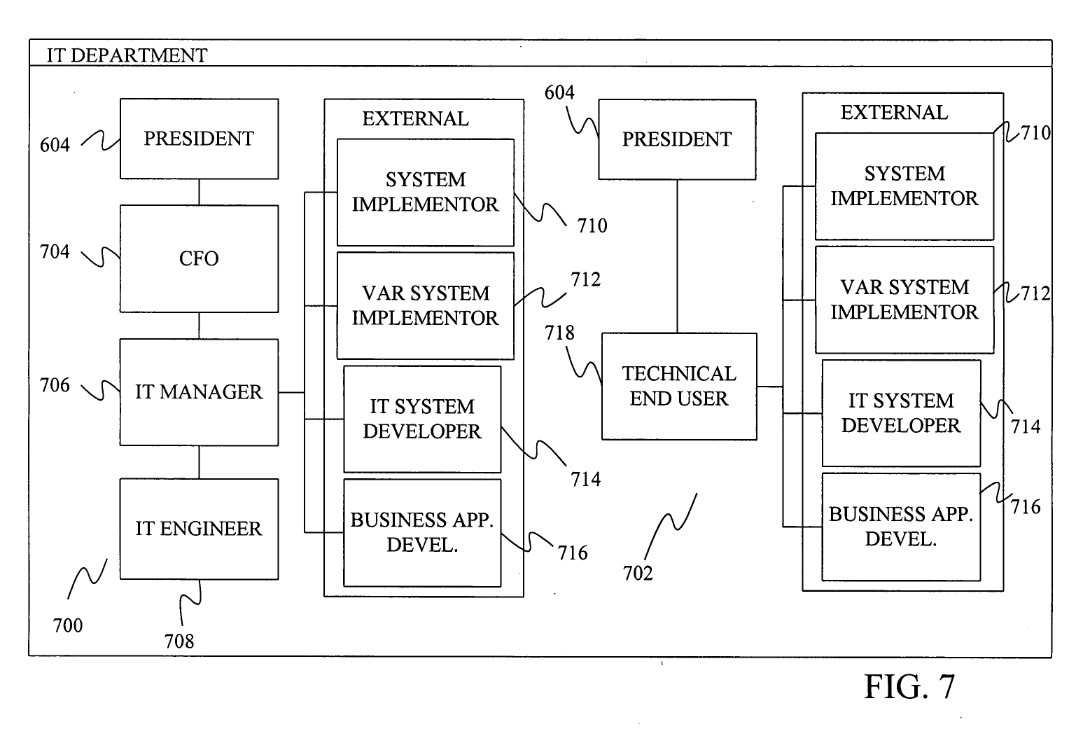

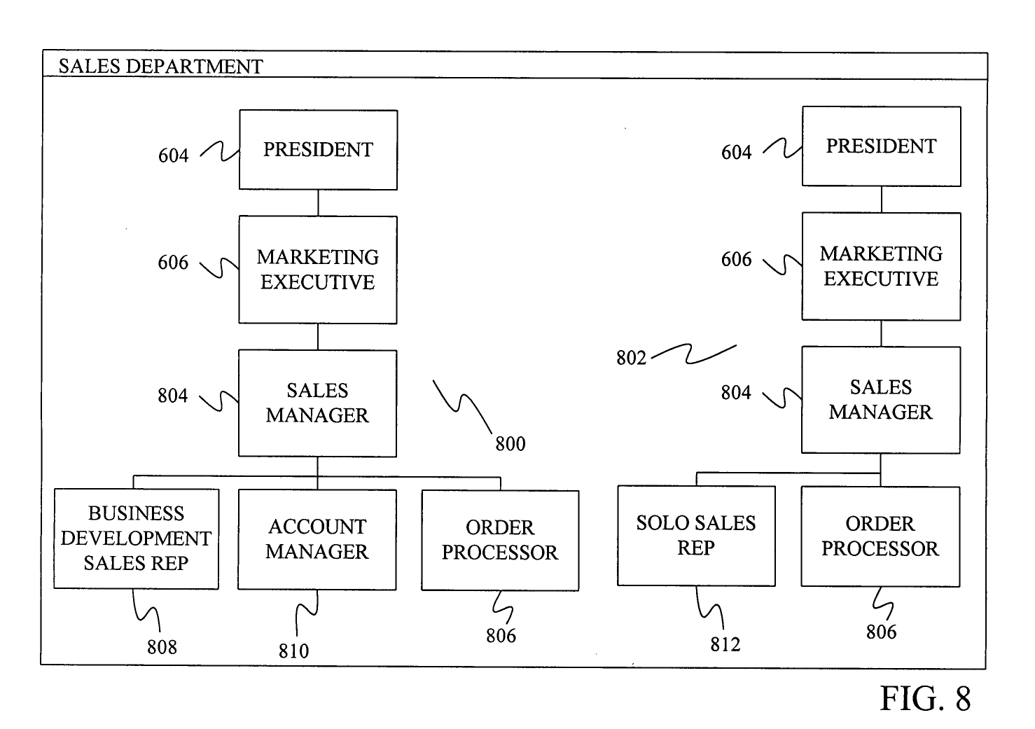

FIGS. 6, 7 and 8 provide example organization structures for a marketing department, an IT department and a sales department, respectively, that are found in department model 510 of generic company model 502. As shown in FIGS. 6, 7 and 8, each department has two possible alternative organization structures. For the marketing department of FIG. 6, there is a large organization structure 600 and a small organization structure 602. For the IT department of FIG. 7, there is a medium organization structure 700 and a small organization structure 702. For the sales department of FIG. 8, there is a complex organization structure 800 and a simple organization structure 802.

Large organization structure 600 of FIG. 6 includes a hierarchy that has a President persona 604 representing the president of the company at the top of the organization structure. Below the President persona is a Marketing Executive persona 606. Below Marketing Executive persona 606 is Marketing Manager persona 608, and below Marketing Manager persona 608 is Marketing Staffer persona 610.

In small organizational structure 602 of FIG. 6, Marketing Executive persona 606 and Marketing Staffer persona 610 are not present leaving only President persona 604 and Marketing Manager persona 608. Although personas 604 and 608 are shown in both large organization structure 600 and small organization structure 602, they would generally have different tasks assigned to them in the persona model depending on which organizational structure is selected. For instance, the tasks performed by Marketing Executive persona 606 in the large organization structure may be shifted to President persona 604 in the small organization structure.

In the medium organization structure 700 of FIG. 7, President persona 604 is found at the top of the hierarchical structure followed by CFO persona 704, IT Manager persona 706 and IT Engineer persona 708. IT Manager persona 706 is connected in the organization structure to external personas such as System Implementer persona 710, Value Added Reseller (VAR) System Implementer persona 712, IT System developer persona 714, and Business Application Developer persona 716.

In small IT organizational structure 702, CFO persona 704, IT Manager persona 706 and IT Engineer persona 708 are replaced by a Power User persona 718, which is positioned below President persona 604. Power User persona 718 represents a technically savvy end user or power user who performs many of the tasks performed by CFO persona 704, IT Manager persona 706 and IT Engineer persona 708 in the medium IT organizational structure. Note that with a smaller organization structure some tasks, such as managing other personas, do not need to be performed. In small IT department organization structure 702, Power User persona 718 is in charge of external personas 710, 712, 714 and 716.

In the complex organizational structure 800 of the sales department in FIG. 8, President persona 604 is placed at the head of the structure followed by Marketing Executive persona 606. Marketing Executive persona 606 in turn is placed in charge of Sales Manager persona 804. Sales Manager persona 804 manages three personas including Business Development Sales Rep persona 808, Account Manager persona 810 and Order Processor persona 806. In simple organizational structure 802 for the sales department, President persona 604 is at the top of the organizational structure followed by Marketing Executive persona 606 and Sales Manager persona 804. In simple organizational structure 802, Sales Manager persona 804 only has responsibility for two personas. Those personas are Solo Sales Representative persona 812, and Order Processor persona 806. Thus, in the simple organizational structure, Solo Sales Representative persona 812 takes on the tasks of Business Development Sales Rep persona 808 and Account Manager persona 810 found in complex organizational structure 800.

In step 402 of FIG. 4, company 500 is compared to generic company model 502 by a model generation process 504. Specifically, at step 402, an organizational structure selection process 511 selects an organization structure for each department from the available organization structures in department model 510 of generic company model 502. Note that depending on the organization of company 500, large organization structures may be selected for some departments while smaller organization structures are selected for other departments. The selection of an organizational structure inherently selects the assignment of tasks to personas in persona model 506 under some embodiments.

At step 404, a comparison process 512 is performed to determine differences between company 500 and generic company model 502 using the selected organization structures. At step 406, the generic company model 502 is modified based on differences between the company and the generic company model to define a persona model 533, a work model 534 and a department model 535 that form a company specific model 513. Modifications to the generic company model can include adding or removing personas from the generic company model, adding or removing tasks or processes from the generic company model and adding or removing departments from department model 510. In addition, personas may be shifted between departments in department 510 and tasks may be shifted between personas within persona model 506.

Company-specific model 513 has the same general form as described for company model 300 of FIG. 3. In particular, work model 534 links tasks together to form flows of tasks representing processes performed in a company. Persona model 533 is capable of receiving a persona defined for the company and identifying tasks in the work model 534 that are performed by the persona. Thus, persona model 533 maps tasks in work model 534 to personas. Department model 535 organizes personas into departments such that the tasks performed by personas in a department define processes in the work model that are assigned to the department. In one embodiment, each task in work model 534 is assigned to at least one persona in persona model 533.

At step 408, the company specific model is evaluated to make improvements to the model. In one embodiment, part of this evaluation is performed by an efficiency module 514, which examines company specific model 513 and provides suggestions through a user interface 516 for changing the company specific model 512 to improve efficiency. These suggested changes can be made based on the movement of business objects between personas in work model 534 to reduce the number of handoffs of the business objects between personas. This can be done by evaluating the process flows found in work model 534.

Under one embodiment, company specific model 512 is also evaluated by a security module 518 at step 408 to determine if it should be changed to improve security. In particular, security module 518 looks at the tasks performed by personas in persona model 533 and determines the security clearance required for each task. If different levels of security clearance are required for the same persona, security module 518 may suggest shifting one or more tasks to other personas through a user interface 520, so that a lower level of security clearance can be assigned to the persona.

After company specific model 513 has been evaluated for improvements, it is provided to consultants 522, which uses the company specific model to suggest software products at step 410. In particular, consultants 522 identify processes in company specific model that can be improved through the development of new software. At step 412, the company specific model is used by a software developer 524 to develop software for use in the processes found in work model 534. By using the company specific model 512, software developer 524 can provide features and organize user interfaces based on one or more the persona model 533, the work model 534 or the department model 535 found within company specific model 512.

Although reference is made above to a company and a generic company, the present invention may be used with other types of organizations such as government departments, military units, Universities, non-profit organizations, hospitals, and professional service organizations, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
comparing a company to a generic company model to identify differences between the company and the generic company model, the generic company model comprising a work model that describes sequences of tasks that form processes performed within a generic company and a persona model that describes generic personas in the generic company and tasks that each generic persona performs; and
using the differences to modify the generic company model to form a company-specific model.

2. The method of claim 1 wherein the generic company model further comprises department models, each department model comprising at least one organization structure and a set of processes performed by generic personas in the organization structure.

3. The method of claim 2 wherein at least one department model comprises multiple alternative organization structures.

4. The method of claim 3 wherein identifying differences between the company and the generic customer model comprises selecting one of the multiple alternative organization structures in a department model and determining the differences between a corresponding organization structure in the company and the selected organization structure.

5. The method of claim 4 wherein a first department model comprises a large first-department organization structure and a small first-department organization structure wherein the large first-department organization structure has more generic personas than the small first-department organization structure and a second department model comprises a large second-department organization structure and a small second-department organization structure wherein the large second-department organization structure has more generic personas than the small second-department organization structure.

6. The method of claim 5 wherein selecting one of the multiple alternative organization structures comprises selecting the large first-department organization structure and the small second-department organization structure.

7. The method 1 wherein identifying differences comprises determining that multiple people perform the tasks of a single persona and modifying the generic company model comprises removing a task from one persona and adding the task to another persona.

8. The method of claim 1 further comprising using the company specific model to identify tasks that can be simplified using software.

9. The method of claim 1 further comprising using the company specific model to add features to a computer program.

10. A computer-readable medium having computer-executable components comprising:
a work model that links tasks together to form processes performed in a company;
a persona model that receives a persona defined for an organization and identifies tasks in the work model that are performed by the persona; and
a department model that organizes personas into departments such that the tasks performed by personas in a department define processes in the work model that are assigned to the department.

11. The computer-readable medium of claim 10 further comprising a security clearance module that uses the persona model to identify tasks associated with a persona, determines the security clearance required for each task, and suggests shifting a task away from a persona based on the security clearance required for the task.

12. The computer-readable medium of claim 10 further comprising an efficiency module that uses the work model and the persona model to identify tasks assigned to one persona in the persona model that could be more efficiently performed by other personas.

13. The computer-readable medium of claim 10 wherein each task in the work model is associated with at least one persona in the persona model.

14. A method comprising:
defining a work model that describes processes performed by a company, each process described as a flow of tasks in the work model;
defining a persona model that maps tasks in the work model to personas; and
determining if a task should be changed based on the work model and the persona model.

15. The method of claim 14 wherein determining if a task should be changed comprises determining if a task should be mapped to a persona based on other tasks mapped to the persona.

16. The method of claim 15 wherein determining if a task should be mapped to a persona comprises determining the security clearance level required for each task mapped to a persona and determining that a task should not be mapped to a persona based on the security clearance level required for the task and the security clearance level required for other tasks.

17. The method of claim 14 wherein determining if a task should be mapped to a persona comprises tracking movement of a business object between personas during a process and determining that a task should not be mapped to a persona in order to reduce movement of the business object.

18. The method of claim 14 further comprising defining a department model that forms hierarchical structures of personas that represent departments.

19. The method of claim 14 wherein defining a work model comprises modifying a generic work model that describes processes performed by a generic company.

20. The method of claim 19 wherein defining a persona model comprises modifying a generic persona model that describes personas found in a generic company.
